(19) United States
(12) Patent Application Publication
(10) Pub. No.: US 2010/0124689 A1
(43) Pub. Date: May 20, 2010

(54) SYSTEM TO RESERVOIR CONNECTOR

(75) Inventors: John Meschter, New York, NY (US); Bryan Grygus, Troy, NY (US); Nagaraja K. Yaddanapudi, Tarrytown, NY (US); Keith Brown, Clifton Park, NY (US); James Prueitt, Ballston Lake, NY (US); Karen Thatcher, East Berne, NY (US); Michael Chen, Cambridge, MA (US); George Allen, Middle Grove, NY (US); Wenpeng Liu, Niskayuna, NY (US); Zhigang Qi, Schenectady, NY (US); Garrick D. S. Smith, Madison, WI (US)

Correspondence Address: BURNS & LEVINSON, LLP, 125 SUMMER STREET, BOSTON, MA, 02110, US

(73) Assignee: MTI MICROFUEL CELLS, INC., Albany, NY (US)

(21) Appl. No.: 12/274,515

(22) Filed: Nov. 20, 2008

(51) Int. Cl. H01M 2/14; B23P 21/00

(52) U.S. Cl. 429/38; 29/469

(57) ABSTRACT

A system-to-reservoir connector is disclosed in which a system-side-sub-connector and a reservoir-side-sub-connector provide for a fluid connection that is resilient to external forces, is substantially leak-proof upon insertion and retraction, and is orientation independent.

### BACKGROUND

The present teachings generally relate to a connector for transporting fluid between a reservoir and a system. In particular, the present teachings relate to a system to reservoir connector for providing positive valve closure on both halves of the connector to minimize fluid loss.

Fuel cells are becoming a more important source of electrical energy for a variety of uses, including personal electronic devices, electric vehicles, and other electrically powered devices. Some liquid fuels can be used directly in direct oxidation fuel cells. When the fuel is methanol, the fuel cell is typically referred to as a direct methanol fuel cell (DMFC). A DMFC is the most suitable fuel cell for portable applications. It offers the users the opportunity to quickly replace an empty fuel cartridges with a full one. However, in conventional systems, the connectors used to connect a fuel cartridge to the fuel cell may leak during attachment and detachment from the fuel cell. Also, external forces may disrupt the fluid transport from the fuel cartridge causing a disruption or fluctuation in the power provided by the fuel cell. In addition, how much fuel can be transferred to the fuel cell is largely dependent on the orientation of the connector. In a less favorable orientation, a large amount of fuel will remain in the cartridge without being able to be transferred to the fuel cell.

Therefore what is needed is a connector that provides positive valve closures on both halves of the connector for minimizing fluid loss upon connect and disconnect, minimizes the effect of external forces on the fluid transport integrity, and is orientation independent.

### SUMMARY

System to reservoir connectors are disclosed. In one instance, a system to reservoir connector is provided in which a system-side-sub-connector and a reservoir-side-sub-connector provide for a fluid connection that is resilient to external forces and is substantially leak proof upon insertion and retraction and is orientation independent.

The system to reservoir connector includes first and second sub-connectors that are complementary to one another and allow for motion of each of the sub-connectors relative to the other. Each of the first and second sub-connectors includes a series of seals, fluid transfer components (a wick in one embodiment, these teachings not being limited to only that embodiment), and collapsible/extendable components (springs in one embodiment, these teachings not being limited to only that embodiment) that ensure positive fluid communication between the two sub-connectors and provide a substantially leak-proof connection.

Embodiments of the system to reservoir connector and methods for use thereof are disclosed.

### BRIEF DESCRIPTION OF THE DRAWINGS

Aspects of the present teachings are pointed out with particularity in the appended claims. The present teachings are illustrated by way of examples in the following drawings in which like references indicate similar elements (except for FIG. 1). The following drawings disclose various embodiments of the present teachings for purposes of illustration only and are not intended to limit the scope of the teachings. For purposes of clarity, not every component may be labeled in every figure. In the figures:

FIG. 1 illustrates the relationship, in one embodiment, between a system, a system-side-sub-connector, a reservoir-side-sub-connector, and a reservoir;

FIG. 2 is a cross sectional view of one embodiment of the system (e.g., a fuel cell engine) side and the reservoir (e.g., fuel supply or cartridge) side sub-connectors of the present teachings.

FIG. 3a is a cross sectional view of one embodiment of the system (e.g., a fuel cell engine) side and the reservoir (e.g., fuel supply or cartridge) sealed together with both valves closed, corresponding to the embodiment of FIG. 2;

FIGS. 3b is a cross sectional view of one embodiment of the system side and the cartridge side sub-connectors sealed together with both valves open, corresponding to the embodiment of FIG. 2;

FIGS. 4a and 4b are cross-sectional views of both the system-side-sub-connector and the reservoir-side-sub-connector in another embodiment of the system of these teachings;

FIG. 4c is a cross-sectional view of both the system-side-sub-connector and the reservoir-side-sub-connector of FIGS. 4a and 4b sealed together with both valves open; and

FIG. 5 is a cross-sectional view of yet another embodiment of the system-side-sub-connector of these teachings.

### DETAILED DESCRIPTION

The following detailed description sets forth numerous specific details to provide a thorough understanding of the teachings. However, those skilled in the art will appreciate that the teachings may be practiced without these specific details. In other instances, well-known methods, procedures, components, protocols, processes, and circuits are not described in detail so as not to obscure the teachings.

Embodiments of a system to reservoir connector in accordance with the present teachings are described in more detail below. The system to reservoir connector includes a first and a second sub-connectors that are complementary to one another and allow for motion of the sub-connectors relative to each other. Each of the first and second sub-connectors includes a series of seals, fluid transfer components (a wick in one embodiment, but these teachings not being limited to only that embodiment) and collapsible/extendable components (springs in one embodiment, but these teachings not being limited to only that embodiment) that ensures positive fluid communication between the two sub-connectors and that provides for a substantially leak-proof connection.

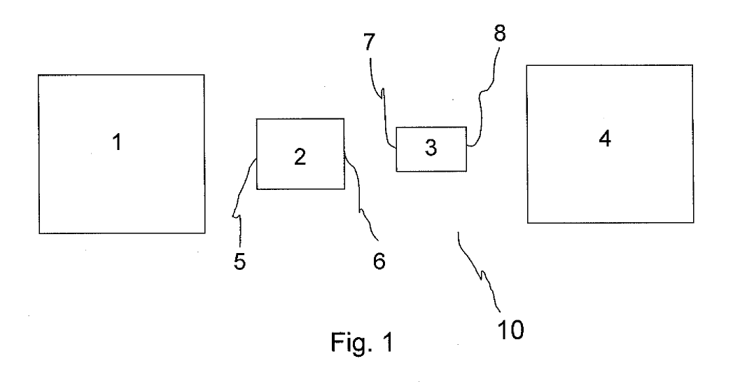

FIG. 1 depicts, in one embodiment, the relationship of a system 1, a sub-connector at the system side, which is referred to as the system-side-sub-connector 2, a sub-connector at the reservoir side, which is referred to as the reservoir-side-sub-connector 3, and a reservoir 4. In one instance, these teachings relate to how to conduct fluid stored in the reservoir 4, to the system 1, through a combination of the system-side-sub-connector 2 and the reservoir-side-sub-connector 3. The fluid is conducted in a substantially smooth manner (not a limitation of these teachings), substantially leak-proof, and in a substantially controlled fashion (not a limitation of these teachings). The end of the system-side-sub-connector that faces the system is referred to as the system end 5, of the system-side-sub-connector, while the other end that faces the reservoir-side-sub-connector is referred to as the reservoir end 6, of the system-side-sub-connector. Likewise, the end of the reservoir-side-sub-connector that faces the reservoir is referred to as the reservoir end 8, of the reservoir-side-sub-connector, while the other end that faces the system-side-sub-connector is referred to as the system end 7, of the reservoir-side-sub-connector. The combination of the system-side-sub-connector and the reservoir-side-sub-connector, in one embodiment, when in a open configuration, enables fluid to flow from the fluid reservoir to the system.

In one embodiment, the system to reservoir connector of these teachings includes a system-side-sub-connector and a reservoir-side-sub-connector. The system-side-sub-connector has a system-side-housing, a fluid transfer component disposed in an interior portion of the system-side-housing and extending from a system end of the system-side-housing to a reservoir end of the system-side-housing, a first portion of the fluid transfer component having a first end proximate to the system end of the system-side-housing; the first portion extending from an exterior of the system end of the system-side-housing to an interior of the system-side-housing, a second portion of the fluid transfer component having a second end proximate to the reservoir end of the system-side-housing, the second portion being able to obtain fluid from the reservoir-side-sub-connector and to provide the obtained fluid to the first portion (being in fluid communication), a system side seal component capable of, in one configuration of the system-side-sub-connector, preventing fluid transfer in/out of the system, and an extendable/collapsible component. The system side seal component includes a first portion disposed substantially coaxially over a portion of the fluid transfer component and a second portion disposed over the second end of the fluid transfer component, the second seal component portion being attachable/detachable (forming a sealed/unsealed form) from the first seal component portion. The extendable/collapsible component is operatively connected to the first seal component portion and capable of enabling to seal/unseal (attachment/detachment) of the first and the second seal component portions; and also capable of retracting the first seal component portion into a second configuration, wherein the first seal component portion not being disposed when in the second configuration, over at least part of the portion of the fluid transfer component.

The reservoir-side-sub-connector can operate in an open configuration or in a closed configuration. The reservoir-side-sub-connector includes a reservoir-side-housing, a reservoir side fluid transfer component adapted to be, when in the open configuration, in fluid communication with the fluid transfer component in the system-side-sub-connector, and a reservoir side seal. In one instance, the reservoir side fluid transfer component is also partially enclosed in the reservoir. In another instance, the reservoir side fluid transfer component comprises the reservoir. Both of these instances are within the scope of these teachings. The reservoir side fluid transfer component is disposed inside the reservoir-side-housing, and has a first reservoir fluid transfer component portion extending from a reservoir side of the reservoir-side-housing to a location inside the reservoir-side-housing, and a second portion of the reservoir fluid transfer component. The second portion of reservoir side fluid transfer component is in fluid communication with the first portion of the reservoir side fluid transfer component. The reservoir side fluid transfer component has a first end proximate to the reservoir and a second end proximate to a system side of the reservoir-side-housing. In one instance, the reservoir side seal is capable of, in the closed configuration, substantially preventing fluid transfer from the second end of the reservoir side fluid transfer component. In one instance, the reservoir side seal component has at least a portion disposed over and operatively connected to another collapsible/extendable component, that portion being capable of being retracted and allowing, when in the open configuration, fluid communication between the reservoir side fluid transfer component and the fluid transfer component of the system-side-sub-connector.

The reservoir-side-housing is sized and dimensioned to have a portion, including the system end of the reservoir-side-housing that is received in the interior of the system-side-housing. In one embodiment, the reservoir-side-housing also has an opening at the system end, that being dimensioned to receive the second end of the fluid transfer component of the system-side-sub-connector, and also being dimensioned to receive the second seal component portion of the system-side-sub-connector. The reservoir-side-housing, in one embodiment, also has a channel extending from an opening at the system end of the reservoir-side-sub-connector to an opening into the interior of the reservoir-side-sub-connector. The channel is dimensioned to receive the second end of the fluid transfer component of the system-side-sub-connector. The channel is also dimensioned to receive the second seal component portion of the system-side-sub-connector.

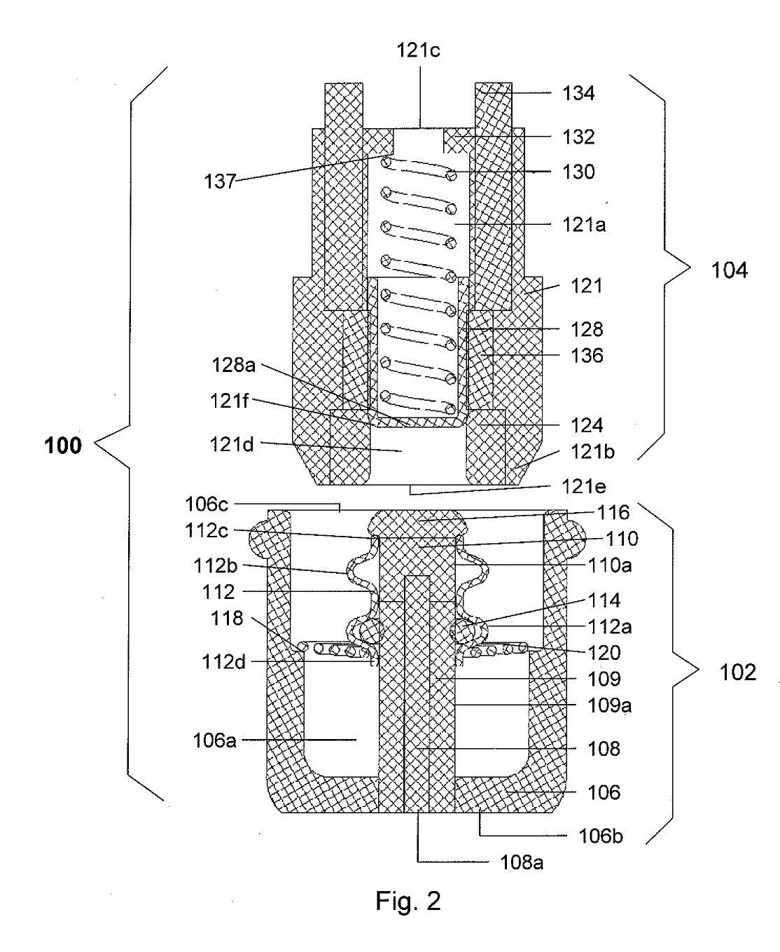

In one instance, the portion of the reservoir-side-housing, including the system end of the reservoir-side-housing, when received in the system-side-housing, operatively connects with the first seal component portion of the system-side-sub-connector and breaks the seal between the first seal component portion and the second seal component portion. The second seal component portion enters into and moves along the channel in the reservoir-side-sub-connector. After the second seal component portion reaches the opening into the interior of the reservoir-side-housing, the second seal component portion operatively connects to the reservoir side seal component and breaks the seal of the reservoir side seal component to get into the interior of the reservoir-side-sub-connector. In one embodiment, the portion of the reservoir-side-housing that is received by the system-side-housing and the channel are dimensioned such that the two housings seal together first, then the seal between the first seal component portion and the second seal component portion of the system-side-housing is broken, and subsequently the seal of the reservoir side seal component opening into the interior of the reservoir-side-sub-connector is broken. One detailed embodiment is shown in FIG. 2.

To allow the fluid to flow through the sub-connectors (and, in the instance where the sub-connectors are in open configuration, the complete connector), it is highly desirable to utilize a capillary flow process. The use of capillary flow process enables flow under almost any type of orientation. Capillary flow via a capillary tube (capillary conduit) is one method to establish this flow. Capillary tubes can be built into both sides of the connector and through capillary action provide continuous feed of fluid through the connector. In addition to capillary tubes, porous materials can be employed to provide capillary flow action through “wick” materials. A “wick,” as used herein, refers to a material of any porosity or permeability that can wick a fluid at a desired (predetermined) flow rate. In one embodiment, the “wick” comprises an absorbent material. Suitable absorbent materials include, but are not limited to, sponges, fibrous polymers such as polyester, polyethylene, polyolefin, polyacetal, and polypropylene, or natural fibers such as hemp, cotton, or cellulose acetate or other plant-based fibers. In one instance, when polymeric fibers are used, these fibers are either thermoset or thermoplastic with high enough softening and/or melting temperatures to withstand potentially high internal temperatures that may exist inside the system such as a fuel cell or inside electronic devices. Although the description hereinbelow concentrates on wick materials, the use of capillary tubes (conduits) is also considered part of the art of this application.

A wick transports a liquid such as fuel (methanol in one exemplary instance) mainly through capillary forces. While not desiring to be bound by theory, one explanation of capillary action is provided below. Capillary action occurs when the adhesive intermolecular forces between the liquid and the surface of a solid are stronger than the cohesive intermolecular forces within the liquid. The Young-Laplace equation states that the capillary pressure, PC, is proportional to the surface tension, γ, and cosine of the contact angle, θ, of the liquid on the surface of the capillary, and inversely proportional to the effective radius, r, of the meniscus formed at the interface, as shown below,

$${P}_{c} = \frac{2 γ cos θ}{r}$$

The fuel (methanol in the exemplary instance) flow in the wick materials is governed by the capillary force, viscous force, and gravity force. As known, methanol is a wetting liquid to most of the surfaces, or, the contact angle is less than 90° with most of the solid materials. Therefore, the capillary force of the methanol in the wick is the key driving force to make it flow, while overcoming the resistant forces, including viscous force and/or gravity. Since the capillary forces can be much stronger than the combined viscous and gravity forces when the diameter of the capillary is made small enough (such as 100 microns), liquid methanol can be wicked in any direction. In other words, the system is basically orientation independent.

Along the wicking flow direction, the methanol would be trying to move to the downstream pores, and then build up a new meniscus in the next available pores. If the next pores are larger, the available methanol will be difficult to build up the new meniscus inside, which leads to a smaller or even zero capillary force to drive the methanol to flow further. Therefore, it is desirable to make sure that the pore size does not get larger along the desired methanol wicking flow direction.

If a single wick is used, it is acceptable to have the pore size or the diameter of capillary tubes be the same along the liquid wicking flow direction. However, it would be preferable if the wick is designed such that the pore sizes or the diameter of capillary tubes decrease along the desired methanol flow direction. If two (or more) wicks are used to transport the liquid, such as the case described herein where there is a cartridge (reservoir) side wick and a system side wick, the pore size or the diameter of capillary tubes within the system side wick should not be larger than that within the cartridge side wick. Preferentially, the pore size or the diameter of capillary tubes within the system side wick is smaller than that within the cartridge side wick so that the methanol flow from the cartridge to the fuel cell system will be facilitated.

FIG. 2 illustrates one detailed embodiment of the system-to-reservoir connector in accordance with the present teachings which is herein schematically shown in a closed position. In particular, the system-to-reservoir connector 100 includes a system side sub-connector portion 102 and a reservoir (cartridge) side-sub-connector portion 104.

In the embodiment shown in FIG. 2, the system-side-sub-connector portion 102 includes system side case 106 that includes an interior portion 106a, a system end 106b, and an end 106c facing the reservoir-side-sub-connector. A fluid transfer component (a wick in the embodiment shown) 108 extends from the exterior of the system end 106b through the interior portion 106a to a fluid transfer component (wick) head 110 that is proximate to the system-side-sub-connector end 106c. Although a wick is shown as the fluid transfer component in FIG. 2, it should be noted that other fluid transfer components, such as, but not limited to, other components capable of capillary action, are also within the scope of these teachings. The wick head 110 has a larger diameter than the wick body 108. An end seal 116 is disposed between wick head 110 and the reservoir (cartridge) end 106c of the case 106 that is larger in diameter than the wick head 110. A fluid transfer component (wick) cover 109 extending the length of the wick from the system end 108a to the wick head 110 is coaxially disposed around the wick 108 and is sized such that the thickness of the wick cover 109 is such that the outer surface 109a is adjacent to the outer surface of the wick head 110a. In one embodiment, the wick cover 109 can also be a seal. A seal housing 112 is coaxially disposed around the wick cover 109 and includes two raised portions 112a and 112b, respectively. A seal 114 may be disposed within one or both of the raised portions 112a and 112b, although a single seal is depicted in the figure disposed within raised portion 112a, an additional seal may be disposed within raised portion 112b. The seal housing has a front portion 112c that is configured and arranged to press against the portion of the end seal 116 that extends beyond the wick head 110 to seal the wick head 110 to prevent leakage therefrom. The seal housing is configured and arranged to slide along the wick cover 109 in order to expose the outer surface 110a of the wick head 110 and allow fluid communication to occur from the wick head 110 under appropriate conditions. A system side extendable/collapsible component (spring) seat 118 is disposed within the interior portion 106a and an extendable/collapsible component (a tension spring in the embodiment shown) 120 is seated on the spring seat 118 and a second end 112d of the seal housing 112. As the seal housing 112 slides toward to the system end 106b, tension spring 120 is extended and biases the seal housing toward the cartridge end 106c.

The reservoir (also referred to as the cartridge, although these teachings are not limited only to a cartridge) side 104 includes a reservoir (cartridge) side case 121 that includes an interior portion 121a, a system end 121b, and a reservoir (cartridge) end 121c. A channel 121d extends from the opening 121e in the system end 121b to an opening 121f in the interior portion 121a of the reservoir side case 121. A hollow piston 128 is coaxially disposed on the longitudinal axis of the cartridge side case 121. A portion of a cover seal 124 is disposed over a system side head 128a of the hollow piston 128. That portion of the cover seal 124 is dimensioned and arranged so that, in the closed configuration, that portion of the cover seal 124 seals the opening 121f into the interior portion 121a. In some embodiments, the hollow piston 128 comprises the cover seal 124 or the cover seal 124 comprises a hollow piston 128. A compression spring 130 is disposed within the hollow piston 128. The compression spring 130 is seated at cartridge spring seat 137 that is disposed against a wall 132 at the cartridge end 121c. A first wick 134 extends through the wall 132 and extends coaxially through the interior portion 121a. A second wick 136 is in fluid communication with first wick 134 and is also coaxially disposed within the interior 121a, but is closer to the longitudinal axis of the cartridge case 121

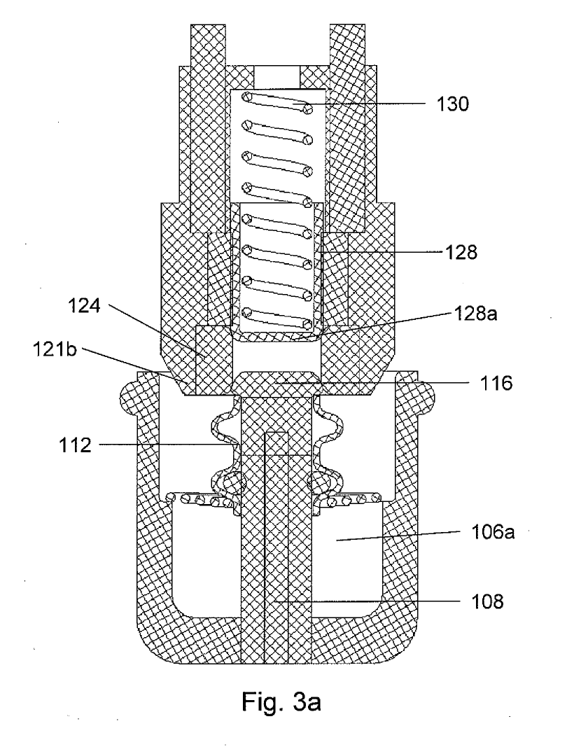

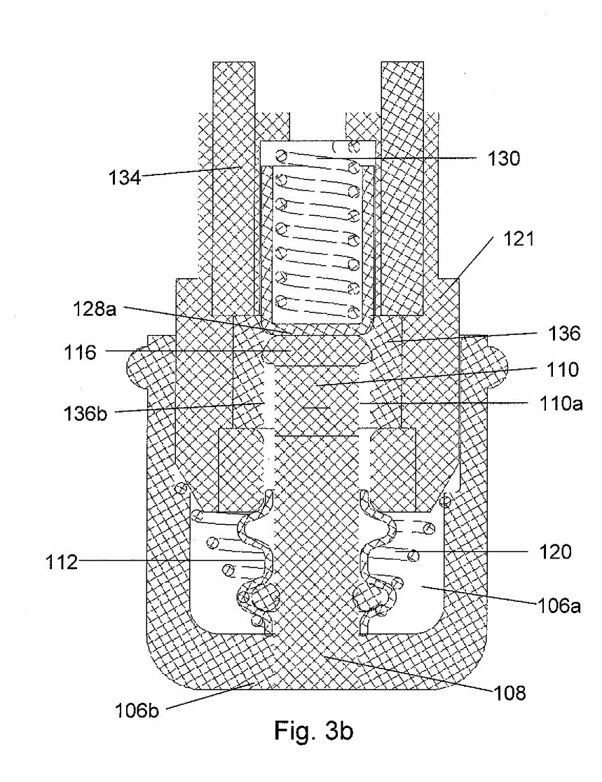

FIG. 3a depicts a cross sectional of the cartridge side 104 being inserted into the system side 102, for the embodiment shown in FIG. 2. The system end 121b of the reservoir side 104 is inserted into the interior 106a of the system side 102 and is seated against the end seal 116. The end seal 116 is located in the vicinity of the head 128a of hollow piston 128 without displacing the hollow piston 128. At this instant in the insertion, seals 116 and 124 and seal housing 112 prevent fluid communication between the two sides and in addition, prevent leakage from either side as well. Also at this instant in the insertion, seals 116 and 124 seal the system-side-sub-connector 102 and the reservoir-side-sub-connector 104 to each other.

Subsequently in the insertion, the system end 121b (FIG. 2) presses against the second raised portion 112b (FIG. 2) of the seal housing and breaks the seal between the seal housing 112 and the end seal 116, allowing fluid flow in the system side 102. The end seal 116 is located substantially adjacent to the head 128a (FIG. 2) of hollow piston 128 without displacing the hollow piston 128. The system side seal housing 112, the end seal 116, and any other seals such as seal 114, comprise system side seal structure. The system side seal structure, being capable of being opened (unsealed) and resealed, constitutes the system side valve.

At a later stage in the insertion, the end seal 116 presses against the head 128a (FIG. 2) of the hollow piston 128 and moves the hollow piston 128 toward the cartridge end 121c and compresses compression spring 130. The end of that later stage results in the cartridge side 104 being engaged within system side 102 and allowing fluid communication between the two sides. As the end seal 116 presses against the head 128a (FIG. 2) and moves the hollow piston 128, the seal between the cover seal 124 and the hollow piston 128 at the opening 121f into the interior portion 121a (FIG. 2) of the reservoir side case 121, is broken. At this stage, the wick head 110 is positioned such that the wick head 110 is in fluid communication with at least a portion of the second wick 136. Fluid flow from the reservoir is now possible. The seal between the cover seal 124 and the hollow piston 128 at opening 121f into the interior portion 121a of the reservoir side case 121, which is capable of being opened (unsealed) and resealed, constitutes a reservoir side valve.

FIG. 3b depicts a cross sectional portion of the cartridge side 104 being engaged within system side 102 and allowing fluid communication between the two sides, for the embodiment shown in FIG. 2. In the engaged position, seal housing 112 has been moved toward system end 106b and has uncovered outer surface 110a of wick head 110. Piston head 128a is adjacent to end seal 116. As the cartridge housing 121 is inserted into interior 106a, the inner surface 136b of second wick 136 is placed adjacent to the now uncovered outer surface 110a of the wick head 110 and is in fluid communication therewith. This configuration allows fluid to flow from the reservoir or fuel cartridge (not shown) to the system such as a fuel cell (not shown) through the first wick 134, second wick 136, wick head 110 and wick 108, respectively. The bias forces of the tension spring 120 and the compression spring 130 are in opposition to one another and allow for a more secure coupling between the cartridge side 104 and the system side 102 making the connection both substantially leak proof and more resilient to external forces as well.

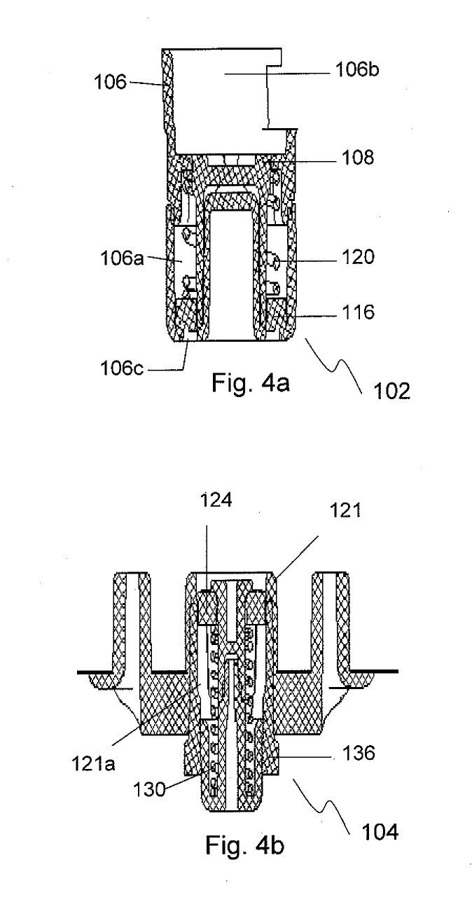

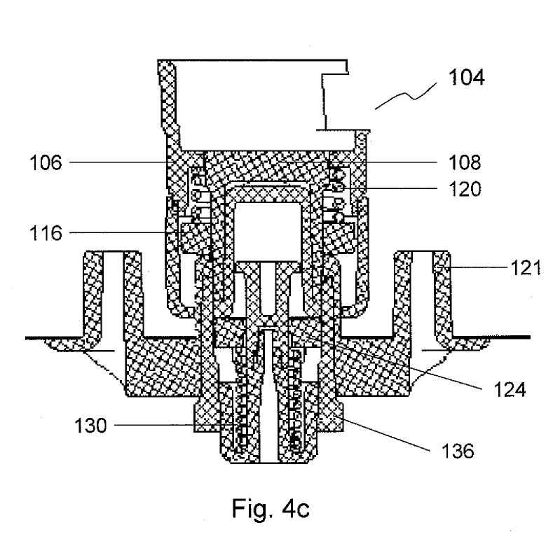

Another embodiment of the system-to-reservoir connector of these teachings (also referred to as “the second embodiment”) is shown (in cross-sectional view) in FIGS. 4a-4c, in which components having the same function as components in FIG. 1 are given the same label. FIG. 4a shows a cross-sectional view of the system-side-sub-connector portion 102 of the second embodiment in which the system side case 106 includes an interior portion 106a, a system end 106b and an end 106c facing the reservoir-side-sub-connector. Also shown in FIG. 4a are the seal 116, the wick 108, and the spring 120. FIG. 4b shows a cross-sectional view of the reservoir (cartridge)-side-sub-connector portion 104 of the second embodiment where the seal 124, the case 121, the spring 130 and wick 136 are labeled. FIG. 4c shows a cross-sectional view of the cartridge side portion 104 engaged within the system side portion 102 and allowing fluid communication between the two sides.

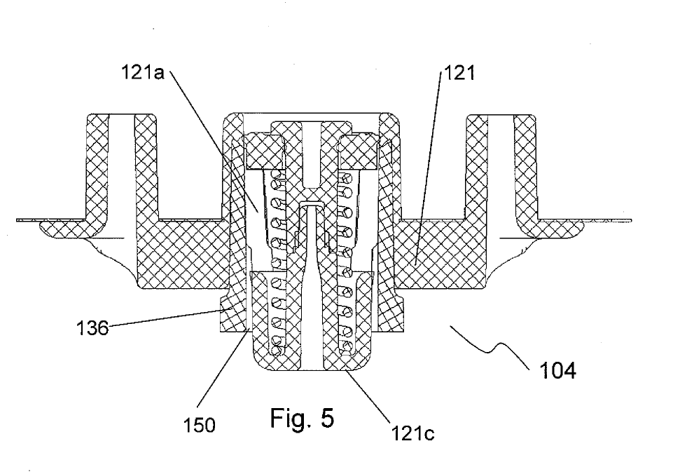

In one instance, during operation, especially, but not limited to, during multiple insertions, fluid can remain in the cartridge-side-sub-connector portion 104, a situation which may lead to unintentional or undesired leakage of fluid to the system-side-sub-connector during insertion. Embodiments of the cartridge-side-sub-connector portion 104 with components or features for allowing transfer of fluid from an interior portion (121a, FIG. 5) of the cartridge (reservoir) side portion 104 of the system-to-reservoir connector of these teachings are within the scope of these teachings.

FIG. 5 shows an embodiment of the cartridge side portion 104 (similar to the embodiment shown in FIG. 4b) with a passage (vent) 150 which can be operatively connected to the cartridge or to another container, thereby allowing remaining fluid to exit from the interior of the cartridge side portion 104 of the sub-connector. Other possible structures that allow remaining fluid to exit from the interior of the cartridge-side-sub-connector 104 are openings (vent holes) in the housing 121, where the openings are located at the cartridge end 121c of the cartridge-side-sub-connector, or openings or vents or structures in the wick 136 that allow remaining fluid to exit from the interior of the cartridge-side-sub-connector 104.

One embodiment of the method for operating the system-to-reservoir connector of these teachings, as described herein above, can be summarized as follows. A connector is provided that has a system-side-sub-connector and a reservoir-side-sub-connector. The system-side-sub-connector and the reservoir-side-sub-connector are initially closed. Each sub-connector has a seal component substantially preventing fluid from flowing out of the sub-connector when in a sealed configuration. The seal component in each sub-connector is capable of being unsealed/sealed and is sealed when the system-side-sub-connector and the reservoir-side-sub-connector are closed. A portion of the reservoir-side-sub-connector is inserted into the system-side-sub-connector while maintaining the seal components in a sealed configuration. First, the reservoir side-sub-connector seals to the system-side-sub-connector. Subsequently, insertion of the portion of the reservoir-side-sub-connector into the system-side-sub-connector continues, rendering the seal component in the system-side-sub-connector in a unsealed configuration, whereby fluid flow into the system-side-sub-connector is enabled. Finally, connecting the reservoir-side-sub-connector to the system-side-sub-connector is completed by completing the insertion, rendering the seal component in the reservoir-side-sub-connector in the unsealed configuration and placing a fluid transfer component in the reservoir-side-sub-connector in fluid communication with a fluid transfer component in the system-side-sub-connector, whereby fluid flow out of the reservoir-side-sub-connector is enabled when connecting a system to a reservoir, leakage of fluid can be substantially prevented by utilizing a system-to-reservoir connector of these teachings.

The corresponding embodiment of the method for closing the system-to-reservoir connector of these teachings is the reverse of the above described embodiment. A portion of the reservoir-side-sub-connector is retracted from the system-side-sub-connector, rendering the seal component in the reservoir-side-sub-connector in the sealed configuration, whereby fluid flow out of the reservoir-side-sub-connector is disabled. Subsequently, the reservoir-side-sub-connector is disengaged from the system-side-sub-connector, rendering the seal component in the system-side-sub-connector in a sealed configuration, whereby flow into the system-side-sub-connector is disabled. Finally, the system-side-sub-connector and reservoir-side-sub-connector are fully separated breaking the final seal between them.

It should be noted that similar systems utilizing flow transfer components other than wicks, different configurations of collapsible/extendable components, other than springs or exchanging compression and tension springs, are also within the scope of these teachings.

It should be noted that the connection between the system-side-sub-reservoir and the system and the connection between the reservoir-side-sub-connector and the reservoir are conventional.

It should be appreciated that other variations to and modifications of the above-described method and system for providing a system-to-reservoir connector may be made without departing from the inventive concepts described herein. Accordingly, the teachings should not be viewed as limited except by the scope and spirit of the appended claims.

What is claimed is:

1. A connector between a system and a reservoir, the connector comprising:
a system-side-sub-connector comprising:
a system-side-housing;
a fluid transfer component disposed in an interior portion of said system-side-housing and extending from a system end of said system-side-housing to a reservoir end of said system-side-housing;
a first portion of said fluid transfer component having a first end proximate to the system end of said system-side-housing; said first portion extending from an exterior of the system end of said system-side-housing to an interior of said system-side-housing;
a second portion of said fluid transfer component having a second end proximate to the reservoir end of said system-side-housing; said second portion of said fluid transfer component being in fluid communication with said first portion of said fluid transfer component; and
a system side seal component; said system side seal component preventing, in a first configuration of said system-side-sub-connector, fluid transfer in/out of the system; at least one portion of said system side seal being disposed over a portion of said fluid transfer component;
and, an extendable/collapsible component operatively connected to said system side seal component; said extendable/collapsible component capable of retracting said system side seal component into a second configuration, said at least a portion of said first seal component not being disposed, when in said second configuration, over at least part of said portion of said fluid transfer component;
and, a reservoir-side-sub-connector, having an open configuration and a closed configuration, said reservoir-side-sub-connector comprising:
a reservoir-side-housing;
a reservoir side fluid transfer component configured to be, when in said open configuration, in fluid communication with said fluid transfer component; said reservoir side fluid transfer component being disposed inside said reservoir-side-housing; and said reservoir side fluid transfer component comprising:
a first reservoir side fluid transfer component portion extending from a location proximate to a reservoir end of said reservoir-side-housing to another location inside said reservoir-side-housing; and
a second portion of said reservoir side fluid transfer component;
said second portion being in fluid communication with said first portion at a first end of said reservoir side fluid transfer component; said reservoir side fluid transfer component also having a second end proximate to a system end of said reservoir-side-housing;
and, a reservoir side seal capable of, in said closed configuration, substantially preventing fluid transfer from said second end of said reservoir side fluid transfer component; said reservoir side seal comprising at least a portion disposed over and operatively connected to another collapsible/extendable component; said at least a portion being capable of being retracted and allowing, when in said open configuration, fluid communication between said reservoir side fluid transfer component and said fluid transfer component;
a portion of said reservoir-side-housing being sized and dimensioned to be received in the interior of said system-side-housing; and said reservoir-side-housing having an opening at the system end of said reservoir-side-sub-connector; said opening at the system end of said reservoir-side-sub-connector leading into an interior of said reservoir-side-sub-connector; said reservoir side seal, in said closed configuration, being capable of sealing said opening into the interior of said reservoir-side-sub-connector; in said closed configuration, fluid flow from said reservoir-side-sub-connector being substantially suppressed;
said reservoir-side-housing and said system-side-housing being dimensioned so that, in said open configuration said fluid transfer component and said reservoir side fluid transfer component are in fluid communication.

2. The system-to-reservoir connector of claim 1 wherein said fluid transfer component comprises a wick; and wherein said reservoir side fluid transfer component comprises a wick.

3. The system-to-reservoir connector of claim 1 wherein said fluid transfer component comprises a capillary conduit; and wherein said reservoir side fluid transfer component comprises a capillary conduit.

4. The system-to-reservoir connector of claim 1 wherein said extendable/collapsible component comprises a spring; and wherein said another collapsible/extendable component comprises a spring.

5. The system-to-reservoir connector of claim 1 wherein said system side seal component comprises:
a seal housing coaxially disposed around a portion of said fluid transfer component; and
a seal disposed within said seal housing and also coaxially disposed around said portion of said fluid transfer component.

6. The system-to-reservoir connector of claim 1 wherein said at least one portion of said system side seal comprises a first and a second seal component portions;
said first seal component portion being disposed over a portion of said fluid transfer component; and,
said second seal component portion disposed over said second end of said fluid transfer component; said second seal component portion being attachable/detachable from said first seal portion;
said extendable/collapsible component enabling sealing/unsealing of a seal between said first and said second seal component portions;
said first seal component portion not being disposed, when in said second configuration, over at least part of said portion of said fluid transfer component.

7. The system-to-reservoir connector of claim 6 wherein said reservoir-side-housing has a channel extending from an opening at the system end of said reservoir-side-sub-connector to an opening into the interior of said reservoir-side-sub-connector; said channel being dimensioned to receive said second end of said fluid transfer component; said channel being also dimensioned to receive said second seal component portion.

8. The system-to-reservoir connector of claim 7 wherein.
said portion of said reservoir-side-housing when received in the interior of said system-side-housing operatively connects to said first seal component portion; said portion of said reservoir-side-housing being capable, upon connecting to said first seal component portion, of separating said first seal component portion from said second seal component portion as said portion of said reservoir-side-housing is inserted into the interior of said system-side-housing; said second seal component portion, as said portion of said reservoir-side-housing is inserted into the interior of said system-side-housing, moves along said channel towards the interior of said reservoir-side-housing, and is capable of, upon reaching said opening into the interior of said reservoir-side-housing, separating said reservoir side seal component from the interior of said reservoir-side-housing;
said portion of said reservoir-side-housing, said channel and said fluid transfer component being sized and dimensioned such that said first seal component portion is first separated from said second seal component portion, and subsequently said reservoir side seal component is separated from the interior of said reservoir-side-housing.

9. The system-to-reservoir connector of claim 1 wherein said reservoir-side-sub-connector comprises means for providing fluid communication from an interior of said reservoir-side-sub-connector to an exterior of said reservoir-side-sub-connector; said means being located proximate to an end of said reservoir-side-sub-connector proximate to the reservoir.

10. The system-to-reservoir connector of claim 9 wherein said means for providing fluid communication comprised a passage from said interior of said reservoir-side-sub-connector to said exterior of said reservoir-side-sub-connector.

11. A system-to-reservoir connector comprising:
a system-side-sub-connector including:
a system side casing including an interior portion, a system end, a reservoir end, a system side longitudinal axis;
a wick having first and second ends, said wick being disposed substantially on said system side longitudinal axis and having a first end extending from the exterior of said system side casing and said wick being disposed within said interior portion and said second end being proximate to said reservoir end;
a wick head having an outer surface and being in fluid communication with said wick and being disposed around said longitudinal axis and on said second end of said wick;
a seal housing being disposed coaxially around a portion of said wick disposed within said interior of said system side casing, said seal housing having a first raised portions, said seal housing being adjacent to and covering said wick head and a portion of said wick;
an end seal disposed adjacent to said wick head and being disposed between said wick head and said reservoir end of said system side casing;
a system side spring seat disposed within said interior portion; and
a first spring seated on said system side spring seat and seated against said first raised portion of said seal housing and configured and arranged to extend toward said system side and to bias said seal housing toward said reservoir side;
a reservoir-side-sub-connector including:
a reservoir side casing being sized and dimensioned to be received within the interior portion of said system side casing, said reservoir side casing including an interior portion, a system end, a reservoir end, a reservoir side longitudinal axis, said reservoir side longitudinal axis being substantially coaxial with said system side longitudinal axis; said reservoir side casing having a channel extending from an opening at the system end to an opening at the interior portion; said channel being dimensioned to receive said wick head; said channel being also dimensioned to receive said end seal;
a center seal;
a hollow piston being disposed on said reservoir longitudinal axis and having a head proximate to said system side and an open end disposed toward said reservoir side and extending a portion of the way toward said reservoir end; at least a portion of said center seal being disposed over said head and being dimensioned to be capable of sealing said channel opening at the interior portion;
a second spring being disposed within said hollow piston and being seated against a second spring seat and said head of said hollow piston; said center seal being operatively connected to said hollow piston and said second spring.
a first wick having a first end extending from said interior portion of said reservoir casing on said reservoir end and a second end disposed within said interior portion of said reservoir casing and being coaxially disposed within said reservoir casing;
a second wick having an inner surface and a first end proximate to said system end and a second end disposed within said interior portion proximate to and in fluid communication with said second end of said first wick, said second wick being coaxially disposed within said interior portion; and
wherein when said reservoir side casing is inserted into said system side casing, said end seal of said reservoir-side-sub-connector is seated against said first raised portion of said seal housing moving said seal housing toward said system side thereby uncovering said wick head and extending said first spring to bias said seal housing toward said reservoir side, said end seal being operative to break said center seal and be seated against said head of said hollow piston and operative to bias said hollow piston toward said reservoir end, wherein said second spring is compressed and biases said hollow piston toward said system end, said inner surface of said first wick being disposed adjacent to and in fluid communication with said outer surface of said wick head, wherein fluid communication from said reservoir-side-sub-connector to said system-side-sub-connector is obtained, wherein said seal housing uncovers said wick head prior to a seal between said central seal and said channel opening at the interior portion being broken.

12. The system-to-reservoir connector of claim 11 wherein said first raised portion of said seal housing includes first and second raised portions, wherein said first seal is disposed within said first raised portion and said end seal is seated against said second raised portion.

13. The system-to-reservoir connector of claim 11 wherein said first spring is a tension spring; and wherein said second spring is a compression spring.

14. A method for substantially preventing leakage while connecting a system and a fluid reservoir, the method comprising the steps of:
providing a connector having a system-side-sub-connector and a fluid reservoir-side-sub-connector; the system-side-sub-connector and the fluid reservoir-side-sub-connector being initially closed; each sub-connector having a seal component substantially preventing flow out of the sub-connector when in a sealed configuration; the seal component being capable of being unsealed/sealed and being sealed when the system-side-sub-connector and the fluid reservoir-side-sub-connector are closed;
inserting a portion of the fluid reservoir-side-sub-connector into the system-side-sub-connector while maintaining the seal components in a sealed configuration;
subsequently, continue inserting the portion of the reservoir-side-sub-connector into the system-side-sub-connector, rendering the seal component in the system-side-sub-connector in an unsealed configuration, whereby fluid flow into/out of the system-side-sub-connector is enabled; and
finally, completing connecting the reservoir-side-sub-connector to the system-side-sub-connector, rendering the seal component in the reservoir-side-sub-connector in the unsealed configuration and placing a fluid transfer component in the reservoir-side-sub-connector in fluid communication with a fluid transfer component in the system-side-sub-connector, whereby flow out of the reservoir-side-sub-connector is enabled.

15. A method for substantially preventing leakage while closing a system and a fluid reservoir, the method comprising the steps of:
providing a connector having a system-side-sub-connector and a reservoir-side-sub-connector; the system-side-sub-connector and the reservoir-side-sub-connector being initially open; each sub-connector having a seal component capable of substantially preventing flow out of said each sub-connector when in a sealed configuration and substantially permitting flow out/in of the sub-connector when in an unsealed configuration; the seal component being capable of being unsealed/sealed and being unsealed when the system-side-sub-connector and the reservoir-side-sub-connector are connected;
retracting a portion of the reservoir-side-sub-connector from the system-side-sub-connector, rendering the seal component in the reservoir-side-sub-connector in the sealed configuration whereby fluid flow out of the reservoir-side-sub-connector is disabled; and
subsequently, disengaging the reservoir-side-sub-connector from the system-side-sub-connector, rendering the seal component in the system-side-sub-connector in a sealed configuration, whereby fluid flow into the system-side-sub-connector is disabled.
